(19) United States
(12) Patent Application Publication
(10) Pub. No.: US 2026/0365008 A1
(43) Pub. Date: Nov. 19, 2026

(54) ELECTRIC WHEEL HUB DRIVE FOR A MOTOR VEHICLE

(71) Applicant: MERCEDES-BENZ GROUP AG, Stuttgart (DE)

(72) Inventors: Fabian SCHWED, Esslingen am Neckar (DE); Michael SCHMIDT, Wernau (DE); Arthur ADAM, Sindelfingen (DE); Johannes DEHN, Hochdorf (DE); Jessica ROOSZ, Esslingen (DE)

(21) Appl. No.: 19/136,599

(22) PCT Filed: Nov. 15, 2023
(86) PCT No.: PCT/EP2023/081954

§ 371 Date: Jun. 6, 2025

(30) Foreign Application Priority Data
Dec. 7, 2022 (DE) 10 2022 004 575.3

(51) Int. Cl. B60K 7/00; H02K 5/10; H02K 7/08; H02K 7/102

(52) U.S. Cl. CPC B60K 7/0007; H02K 5/10; H02K 7/08; H02K 7/102; B60K 2007/0038

(57) ABSTRACT

An electric wheel hub drive for a motor vehicle includes a wheel carrier, a wheel bearing, a brake disc carrier, an electric engine, a stator carrier connected to the wheel carrier for conjoint rotation, and a rotor carrier which is connected to the rotor for conjoint rotation. To seal a rotor space that includes an intermediate space between the rotor and stator, a first seal is arranged coaxially to the rotor carrier in such a way that a first intermediate gap is filled by the first seal between the rotor carrier and the stator carrier. A second seal is arranged coaxially to the rotor carrier in such a way that a second intermediate gap is filled by the second seal between the rotor carrier and the brake disc carrier.

### BACKGROUND AND SUMMARY OF THE INVENTIONS

Exemplary embodiments of the invention relate to an electric wheel hub drive for a motor vehicle.

A decoupler (disconnect unit) can be used in an electric wheel hub drive for a motor vehicle. For example, a servomotor is used for actuating the decoupler. Foreign bodies or fluids may not penetrate into the wheel hub drive.

DE 10 2009 035 176 A1 describes a wheel hub drive for a motor vehicle, having an electric engine and a disc brake system which are both arranged radially inside a wheel rim. So that both the E-engine as well as the disc brake system can be used in the wheel hub drive at the desired output, a stator of the electric engine has a recess, with a brake caliper of the disc brake system being arranged in this recess.

Exemplary embodiments of the invention are directed to a novel electric wheel hub drive for a motor vehicle.

In the context of the present application, the term “for conjoint rotation” is used as follows: Two elements are connected to each other for conjoint rotation when they are arranged coaxially to each other (in relation to their rotational axis or in relation to an axis of rotational symmetry) and when they are connected to each other in such a way that they always rotate at the same angular velocity. An element is connected to a housing for conjoint rotation when it cannot be rotated relative to the housing.

In the context of the present application, the term “radially overlapping” is used as follows: Two (in particular substantially rotationally symmetrical) elements are arranged radially overlapping in relation to a common axis when they are each at least partially arranged in a region of the same radial coordinates (in particular of the same angular coordinates).

In the context of the present application, the term “axially overlapping” is used as follows: Two elements are arranged axially overlapping relative to a common axis when they are each at least partially arranged in a region of the same axial coordinates.

According to the invention, an electric wheel hub drive for a motor vehicle is proposed, having a wheel carrier, having a wheel bearing which has a first bearing ring connected to the wheel carrier for conjoint rotation and a second bearing ring arranged so as to be rotatable with respect to a main rotational axis, having a brake disc carrier connected to the second bearing ring for conjoint rotation, having an electric engine which has a stator and a rotor, having a stator carrier connected to the wheel carrier for conjoint rotation, having a rotor carrier which is connected to the rotor for conjoint rotation, having a decoupler designed to connect the rotor carrier to the second bearing ring for conjoint rotation, wherein in order to seal a rotor space that includes an intermediate space between the rotor and stator, a first seal is arranged coaxially to the rotor carrier in such a way that a first intermediate gap is filled by the first seal between the rotor carrier and the stator carrier. According to the invention, a second seal is provided, which is arranged coaxially to the rotor carrier in such a way that a second intermediate gap is filled by the second seal between the rotor carrier and the brake disc carrier.

The brake disc carrier is thus permanently connected to the second bearing ring for conjoint rotation, wherein the rotor carrier is not permanently connected to the second bearing ring for conjoint rotation but can be connected to the second bearing ring and thus also to the brake disc carrier via the decoupler for conjoint rotation.

The intermediate gap may be a gap delimited on one side by the rotor carrier and on another side by the brake disc carrier. The second seal lies tightly against the rotor carrier on the one side. The second seal lies tightly against the brake disc carrier on the one other side. The intermediate gap may be a gap that is either axially delimited on a first axial side of the intermediate gap by the rotor carrier and on the other axial side of the intermediate gap by the brake disc carrier or may be a gap which is radially delimited on a first radial side of the intermediate gap by the rotor carrier and on the other radial side of the intermediate gap by the brake disc carrier.

The first seal and the second seal serve to fluid-tightly seal the rotor space in which the rotor is located.

The second seal is advantageously designed as a shaft sealing ring. If the decoupler is open, so that the decoupler is in a decoupled state, the brake disc carrier rotates with the rolling vehicle, while the rotor carrier does not rotate, for example.

In one embodiment, the second seal is arranged axially on a side of the first seal facing away from the wheel carrier, relative to the main rotational axis.

In one embodiment, the electric engine is designed as an axial flux machine and the second seal is arranged axially on a side of the stator facing away from the first seal, relative to the main rotational axis.

In one embodiment, the second seal is arranged radially inside the stator.

In one embodiment, the first seal is arranged radially inside the rotor.

In one embodiment, a first connection point for connecting the brake disc carrier to the second bearing ring is arranged radially inside the second seal.

In one embodiment, a brake disc is connected to the brake disc carrier for conjoint rotation and is arranged axially on a side of the first seal, opposite the second seal, with regard to the main rotational axis.

In one embodiment, a third seal is arranged coaxially to the rotor carrier in such a way that a third intermediate gap is filled by the third seal between the first bearing ring and the second bearing ring.

In one embodiment, there is a second connection point for connecting the first bearing ring to the stator carrier.

In one embodiment, a fourth seal is arranged on the side of the wheel bearing axially opposite the third seal, between the second bearing ring and the first bearing ring.

In one embodiment, the first bearing ring is a radially outer bearing ring of the wheel bearing and the second bearing ring is a radially inner bearing ring of the wheel bearing.

In one embodiment, the first bearing ring is connected for conjoint rotation to a third bearing ring, which is simultaneously a radially inner bearing ring of a rotor bearing, wherein a radially outer bearing ring of the rotor bearing is connected to the rotor carrier for conjoint rotation.

The present invention prevents foreign bodies or fluids from penetrating into the drive module. The use of the wheel bearing seal as one of the sealing points reduces the drag losses compared to additional seals. Additional seals can be used for integration of the mechanical disconnect.

As the wheel bearing seal is included in the sealing of the intermediate space between the rotor and stator, only two additional seals are required to seal this intermediate space.

The radial seals separate the two spaces even during rotation and tilting, typical for wheels, of the components under the action of lateral force and thus prevent the penetration of the described substances. Furthermore, they prevent the leaking, i.e. leakage, of lubricating substances from the mechanical components, for example grease or oil from an oil chamber or oil sump. This is achieved by a seal between the rotor and stator, rotor, and wheel bearing and the use of the wheel bearing seal.

Exemplary embodiments of the invention are explained in more detail in the following using the drawings.

### BRIEF DESCRIPTION OF THE DRAWING FIGURES

In the figures:

FIG. 1 shows a schematic view of an electric wheel hub drive for a motor vehicle, and

FIG. 2 shows a schematic view of the electric wheel hub drive for clarifying a rotor space.

Parts corresponding to each other are provided with the same reference numerals in all the figures.

### DETAILED DESCRIPTION

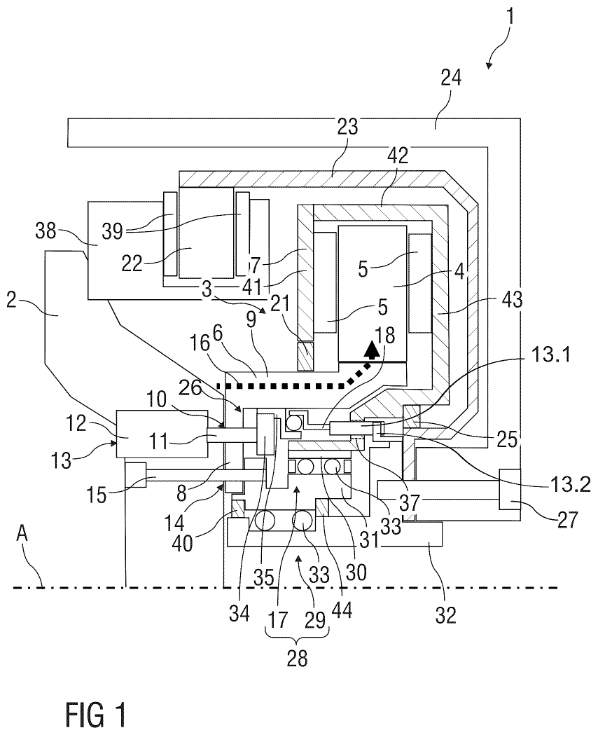

FIG. 1 shows a schematic view of an electric wheel hub drive 1 for a motor vehicle, having a wheel carrier 2, an electric engine 3 that has a stator 4 and a rotor 5 arranged so as to be rotatable around a main rotational axis A, a stator carrier 6 connected to the wheel carrier 2 for conjoint rotation, a rotor carrier 7 connected to the rotor 5 for conjoint rotation and rotatably mounted so as to be rotatable relative to the wheel carrier 2. The stator carrier 6 has a disc section 8 and a cylinder section 9 and the cylinder section 9 is arranged radially outside the disc section 8.

Particularly advantageously, here the stator carrier 6 is directly connected to the wheel carrier 2, so that the stator carrier 6 lies directly on the wheel carrier 2.

The disc section 8 substantially has a plate shape. The plate shape substantially means a sheet metal component that is advantageously rotationally symmetrical relative to the main rotational axis A, wherein the disc section 8 advantageously has an opening arranged rotationally symmetrically to the main rotational axis A in the radially inner region around the main rotational axis. The disc section 8 is substantially parallel to a plane that is arranged perpendicular to the main rotational axis A, or the disc section 8 is slightly curved relative to the plane that is arranged perpendicular to the main rotational axis A.

The disc section 8 has a first passage 10 for a shaft 11 of an actuator 12 of a decoupler 13.

The decoupler 13 is designed to couple the rotor carrier 7 to the wheel rim 24 for conjoint rotation. A coupled state can be produced by means of the decoupler 13, in which the rotor carrier 7 is connected to the wheel rim 24 for conjoint rotation. A decoupled state can also be produced by means of the decoupler 13, in which the rotor carrier 7 is decoupled from the wheel rim 24 and the rotor carrier 7 can therefore rotate relative to the wheel rim 24. As no power loss occurs in the electric engine in the decoupled state, the decoupled state serves to save energy in an operating mode in which the wheel rim 24 is not driven by the rotor 5, but in which the wheel rim 24 nevertheless rotates because, for example, the motor vehicle is rolling without drive power from the electric engine 3.

The first passage 10 is advantageously designed in a direction which is arranged parallel to the main rotational axis A.

A first coupling half 13.1 and a second coupling half 13.2 of the decoupler 13 are each arranged radially inside the cylinder section 9 and axially overlapping this. The first coupling half 13.1 is connected to the rotor carrier 7 for conjoint rotation. The second coupling half 13.2 is connected to the wheel rim 24 for conjoint rotation. The first coupling half 13.1 and the second coupling half 13.2 can be connected to each other for conjoint rotation.

Advantageously, the first coupling half 13.1 and the second coupling half 13.2 have interfitting claw teeth.

Advantageously, the first coupling half 13.1 can be designed to be axially displaceable. Advantageously, the decoupler 13 has a displacement mechanism 26 which is designed to bring the coupling halves 13.1, 13.2 into engagement with each other.

Advantageously, the displacement mechanism 26 is designed to axially displace the first coupling half 13.1.

The displacement mechanism 26 advantageously has a ring 18 designed in such a way that it is connected to the cylinder section 9 for conjoint rotation and can be displaced axially relative to the cylinder section 9. Advantageously, the cylinder section 9 has a groove (not shown), arranged parallel to the main rotational axis A, into which an engagement element connected firmly to the ring 18 engages.

The ring 18 lies on the first coupling half 13.1 so that axial displacement of the ring 18 in the direction of the first coupling half 13.1 also displaces the first coupling half 13.1. The first coupling half has claw teeth, each of which is mounted in a respective passage 37 in the rotor carrier 7 and is designed for optional engagement with the second coupling half 13.2.

A pinion 34 is furthermore arranged on the shaft 11, which pinion is connected to the ring 18 via a release bearing 35. The displacement mechanism 26 comprises the pinion 34 and the release bearing 35. The release bearing 35 is ring-shaped and is arranged coaxially to the main rotational axis A. The release bearing 35 has internal teeth which engage with the pinion 34. The release bearing 35 has a ramp structure acting in the axial direction, such that a rotation of the release bearing 35 causes axial displacement of the ring 18.

Particularly advantageously, the displacement mechanism 26 having the release bearing 35 is designed in such a way that a rotation of the release bearing 35 causes axial displacement of the first coupling half 13.1.

Particularly advantageously, the pinion 34 and the release bearing 35 are arranged radially inside the cylinder section 9 and axially overlapping this.

Advantageously, the disc section 8 has second passages 14 for screw connections 15, which are designed to connect the disc section 8 to the wheel carrier 2 for conjoint rotation. The second passages 14 are advantageously designed in directions which are arranged parallel to the main rotational axis A.

Advantageously, the second passages 14 are substantially arranged in a region of smaller radii than the first passage 10, in relation to the main rotational axis A.

In one embodiment, the cylinder section 9 has at least one channel 16 designed for receiving a coolant. Advantageously, the channel 16 has a first section arranged parallel to the main rotational axis A on a side facing towards the wheel carrier 2. Advantageously, the channel 16 has a second section in a region arranged axially overlapping the stator 4, which second section is arranged perpendicular to the main rotational axis A.

A rotor bearing 17 for rotationally mounting the rotor 5 is provided and is arranged radially inside and axially overlapping the channel 16. The rotor 5 is rotationally mounted indirectly with respect to the wheel carrier 2 by means of the rotor bearing 17.

In one embodiment, the cylinder section 9 has a sealing surface for a seal 21, in particular a radial seal, on its radially outer side. The seal 21 fills a gap between the rotor carrier 7 and the cylinder section 9. The seal 21 lies on a radially outer ring surface of the cylinder section 9 and the seal 21 lies on a radially inner ring surface of the rotor carrier 7. The seal 21 thus lies radially outside the radially outer ring surface of the cylinder section 9 and radially inside the radially inner ring surface of the rotor carrier 7.

Particularly advantageously, the sealing surface 21 is arranged axially between the stator 4 and a brake disc 22.

The rotor bearing 17 is part of a combined bearing 28 that furthermore comprises a wheel bearing 29. The combined bearing 28 has a third bearing ring 30, a first bearing ring 31, and a second bearing ring 32. A plurality of rolling elements is arranged between the third bearing ring 30 and the first bearing ring 31, which belong to the rotor bearing 17. A plurality of rolling elements 33 is arranged between the first bearing ring 31 and the second bearing ring 32 which belong to the wheel bearing 29.

The brake disc 22 can be designed as an inside-out brake disc and can be arranged on a brake disc carrier 23 connected to a wheel rim 24 for conjoint rotation.

The wheel rim 24 and the brake disc carrier 23 are particularly advantageously connected to the second bearing ring 32 of the wheel bearing 29 via several wheel screws 27 for conjoint rotation.

A second seal 25 is advantageously arranged between the brake disc carrier 23 and the rotor carrier 7. Advantageously, the second seal 25 lies directly on a radially outer sealing surface of the brake disc carrier 23. The second seal 25 lies advantageously on a radially inner sealing surface of the rotor carrier 7.

A brake caliper 38 with brake pads 39 is furthermore arranged on the wheel carrier 2. The brake caliper 38 here is advantageously designed as an internal brake caliper 38.

The wheel carrier 2, the brake caliper 38, the brake pads 39, the stator 4, the stator carrier 6, the actuator 12, the shaft 11, the pinion 34, and the first bearing ring 31 do not rotate with the wheel rim 24.

The brake disc 22, the brake disc carrier 23, the second bearing ring 32, and the second coupling half 13.2 always rotate together with the wheel rim 24.

The rotor carrier 7, the rotor 5, the first coupling half 13.1, and the third bearing ring 30 only rotate with the wheel rim 24 when the decoupler 13 is engaged, which means when the first coupling half 13.1 is engaged with the second coupling half 13.2.

The electric engine 3 is advantageously designed as an axial flux machine.

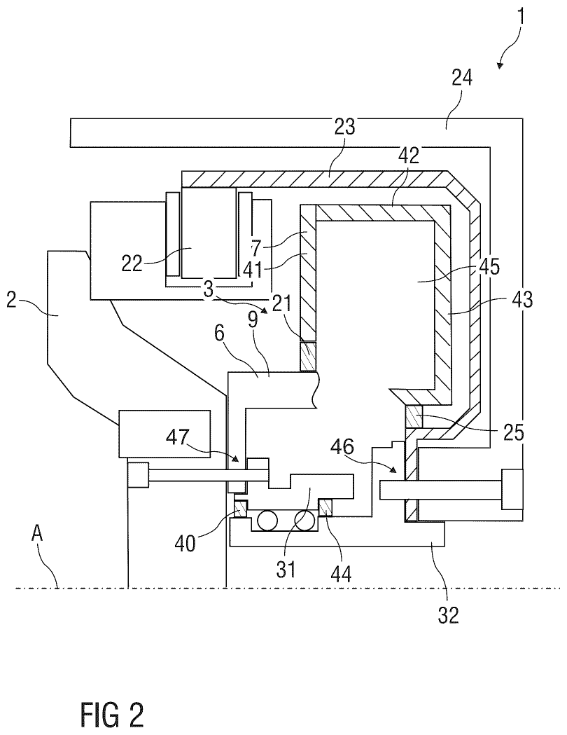

FIG. 2 is a schematic view of the electric wheel hub drive 1, with the omission of components arranged inside a rotor space 45.

To seal the rotor space 45, in particular an intermediate space between the rotor 5 and the stator 4, a seal 21 is advantageously provided that is arranged coaxially to the rotor carrier 7 in such a way that a first intermediate gap is filled by the seal 21 between the rotor carrier 7 and the stator carrier 6.

The second seal 25 is arranged coaxially to the rotor carrier 7 in such a way that a second intermediate gap is filled between the rotor carrier 7 and the brake disc carrier 23 by the second seal 25.

With respect to the main rotational axis A, the second seal 25 is advantageously arranged axially on a side of the first seal 21 facing away from the wheel carrier 2.

The second seal 25 is advantageously arranged radially inside the stator 4, which means radially inside the region of magnets arranged in the stator 4.

The seal 21 is advantageously arranged radially inside the rotor 5, which means radially inside the region of magnets arranged in the rotor 5.

A first connection point 46 for connecting the brake disc carrier 23 to the second bearing ring 32 is advantageously arranged radially inside the second seal 25.

The brake disc 22, which is connected to the brake disc carrier 23 for conjoint rotation, is advantageously arranged on a side of the first seal 21, opposite the second seal 25, axially with regard to the main rotational axis A.

A third seal 40 is advantageously furthermore arranged coaxially to the rotor carrier 7 in such a way that a third intermediate gap is filled by the third seal 40 between the first bearing ring 31 and the second bearing ring 32, which can also be referred to as second bearing ring.

Furthermore, a second connection point 47, which is advantageously fluid-tight, is provided for the conjoint-rotation connection of the first bearing ring 31 to the stator carrier 6. Thus, the rotor space 45 is closed in a fluid-tight manner. The stator carrier 6 has the cylinder section 9, which is sealed by means of the first seal 21 with respect to a first disc-shaped part 41 of the rotor carrier 7, which lies on one side of the stator 4 when viewed axially. The rotor carrier 7 furthermore has a cylindrical part 42 and a second plate-shaped part 43 that is connected to the cylindrical part 42 and that is sealed with respect to the brake disc carrier 23 by means of the second seal 25. The brake disc carrier 23 has the first connection point 46 as a sealed connection point for connection to the second bearing ring 32. The second bearing ring 32 is sealed with respect to the first bearing ring 31 by means of the third seal 40. The first bearing ring 31 has the sealed second connection point for connection to the stator carrier 6.

A fourth seal 44 can furthermore be provided between the second bearing ring 32 and the first bearing ring 31 on the side of the wheel bearing 29 that is axially opposite the third seal 40.

The first bearing ring 31 can be designed as a single, integral bearing shell, which forms both a radially outer part of the wheel bearing 29 and also a radially inner part of the rotor bearing 17. Alternatively, the first bearing ring 31 can also be designed as two bearing shells, connected to each other for conjoint rotation, of which one is a radially outer part of the wheel bearing 29 and the other is a radially inner part of the rotor bearing 17.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 electric wheel hub drive
2 wheel carrier
3 electric engine
4 stator
5 rotor
6 stator carrier
7 rotor carrier
8 disc section
9 cylinder section
10 passage
11 shaft
12 actuator
13 decoupler
13.1 first coupling half
13.2 second coupling half
14 passage
15 screw connection
16 channel
17 rotor bearing
18 ring
21 seal
22 brake disc
23 brake disc carrier
24 wheel rim
25 second seal
26 displacement mechanism
27 wheel screw
28 combined bearing
29 wheel bearing
30 third bearing ring
31 first bearing ring
32 second bearing ring
33 rolling elements
34 pinion
35 release bearing
37 passage
38 brake caliper
39 brake pad
40 third seal
41 first disc-shaped part
42 cylindrical part
43 second disc-shaped part
44 fourth seal
45 rotor space
46 first connection point
47 second connection point
A main rotational axis

1-12. (canceled)

13. An electric wheel hub drive for a motor vehicle, the electric wheel hub drive comprising:
a wheel carrier;
a wheel bearing having a first bearing ring connected to the wheel carrier to conjointly rotate and a second bearing ring arranged so as to be rotatable with respect to a main rotational axis;
a brake disc carrier connected to the second bearing ring to conjointly rotate;
an electric engine comprising a stator and a rotor;
a stator carrier connected to the wheel carrier to conjointly rotate;
a rotor carrier connected to the rotor to conjointly rotate; and
a decoupler configured to connect the rotor carrier to the second bearing ring to conjointly rotate,
a first seal configured to seal a rotor space that includes an intermediate space between the rotor and stator, wherein the first seal is arranged coaxially to the rotor carrier in such a way that a first intermediate gap is filled by the first seal between the rotor carrier and the stator carrier, and
a second seal arranged coaxially to the rotor carrier in such a way that a second intermediate gap is filled by the second seal between the rotor carrier and the brake disc carrier.

14. The electric wheel hub drive of claim 13, wherein the second seal is arranged axially on a side of the first seal facing away from the wheel carrier, relative to a direction of the main rotational axis.

15. The electric wheel hub drive of claim 14, wherein the electric engine is an axial flux machine and the second seal is arranged axially on a side of the stator facing away from the first seal, relative to the direction of the main rotational axis.

16. The electric wheel hub drive of claim 13, wherein the second seal is arranged radially inside the stator relative to the main rotational axis.

17. The electric wheel hub drive of claim 13, wherein the first seal is arranged radially inside the rotor.

18. The electric wheel hub drive of claim 13, further comprising:
a first connection point, configured to connect the brake disc carrier to the second bearing ring, is arranged radially inside the second seal relative to the main rotational axis.

19. The electric wheel hub drive of claim 18, further comprising:
a brake disc connected to the brake disc carrier to conjointly rotate, wherein the brake disc is arranged axially on a side of the first seal, opposite the second seal, relative to the main rotational axis.

20. The electric wheel hub drive of claim 13, further comprising:
a third seal arranged coaxially to the rotor carrier in such a way that a third intermediate gap is filled by the third seal between the first bearing ring and the second bearing ring.

21. The electric wheel hub drive of claim 18, further comprising:
a second connection point configured to connect the first bearing ring to the stator carrier.

22. The electric wheel hub drive of claim 20, further comprising:
a fourth seal arranged between the second bearing ring and the first bearing ring and is arranged on a side of the wheel bearing axially opposite the third seal.

23. The electric wheel hub drive of claim 13, wherein the first bearing ring is a radially outer bearing ring of the wheel bearing and the second bearing ring is a radially inner bearing ring of the wheel bearing.

24. The electric wheel hub drive of claim 13, wherein the first bearing ring is connected to conjointly rotate to a third bearing ring, which is simultaneously a radially inner bearing ring of a rotor bearing, wherein a radially outer bearing ring of the rotor bearing is connected to the rotor carrier to conjointly rotate.
